(19) United States
(12) Patent Application Publication
(10) Pub. No.: US 2014/0140569 A1
(43) Pub. Date: May 22, 2014

(54) FOLDED DIAPHRAGM LOUDSPEAKER

(71) Applicant: ACUSTICA BEYMA, S.L., Moncada ( Valencia) (ES)

(72) Inventors: Jose Martinez Iranzo, MONCADA (VALENCIA) (ES); Rita Martinez Pla, MONCADA (VALENCIA) (ES)

(73) Assignee: ACUSTICA BEYMA, S.L., MONCADA (VALENCIA) (ES)

(21) Appl. No.: 13/682,997

(22) Filed: Nov. 21, 2012

(51) Int. Cl. H04R 9/02

(52) U.S. Cl. CPC H04R 9/025
USPC 381/412

(57) ABSTRACT

A folded diaphragm loudspeaker of the type used in the manufacture of audio equipment, includes a first magnetic circuit board having at least one magnet and two pole parts (7) formed from a flexible printed circuit board, where between a folded diaphragm (1) is housed, having folds with a greater cross-section in its most external part with respect to the internal folds, characterised in that the diaphragm (1) is fixed in its entirety to a frame (4), except in one of its ends, where the diaphragm (1) is joined to a rigid support (3) associated with a bowed steel strip or band (2) that tenses the folded diaphragm (1) in the direction of its folds.

### FIELD OF THE INVENTION

The main object of the present invention is a folded diaphragm of the type used in the manufacture of audio equipment.

### STATE OF THE ART

In general, a loudspeaker is composed of a cone-shaped diaphragm attached to a vibrating moving cylindrical coil disposed inside equally cylindrical fixed magnetic pole parts.

This traditional configuration has the drawback that, when a high level of power is applied to the loudspeaker, a considerable amount of heat is generated by the coil and methods or systems to dissipate said heat must be used. However, it is not always possible to dissipate this heat (despite the fact that the movement of the vibrating coil makes the air circulate around it and cool it slightly), which leads to malfunctions.

There are solutions in the current state of the art aimed at avoiding said concentration of heat, such as for example, distributing the electrical conductor of the coil over the entire surface of a flat, corrugated or folded diaphragm, disposing said diaphragm between sets of pole parts that are also flat and/or longitudinal, in such a manner that when an AC signal is applied to the coils, these are subject to alternative attractive and repulsive forces by the pole parts, producing a sound vibration.

An example of this is Spanish patent ES 2 376 731A1, held by the same applicant, which discloses a folded diaphragm loudspeaker used in the manufacture of audio equipment, consisting of a baffle having an electro-acoustic transducer composed of a vibrating moving folded flat diaphragm whereto a conducting track is fixed, embedded or attached by any means in a vertical zig-zag pattern, wherein the diaphragm is folded with vertical folds or corrugations. Said diaphragm is mounted between two circuit boards composed of fixed longitudinal magnetic pole parts disposed parallel to the diaphragm, one at the front and another at the rear, wherein the back part of the rear plate is lined with an acoustic insulating lamina made of felt or similar material, characterised essentially in that the conducting track has a smaller electrical cross-section in the central part of the diaphragm than on the sides thereof. The suspension system is configured in such a manner that the tension of the diaphragm is maintained by means of a fastener, pin or traction clip, which exerts greater traction in the central folds than in the side folds. Said fastener, pin or traction clip is preferably disposed on the lower part of the diaphragm, which has a fan-forced air cooling circuit that allows the air to firstly reach the central part of the diaphragm.

### EXPLANATION OF THE INVENTION

The loudspeaker advocated herein is based on AMT (Air Motion Transformer) technology and is characterised in that it transforms an electrical current into sound waves through the movement of air. The main difference with a conventional moving coil loudspeaker is that the sound is not produced by the alternating movement of a membrane, but rather by means of the clamping effect of an accordion-folded diaphragm.

The invention relates to this type of transducer and its object is to facilitate the application of greater electrical power without damaging or destroying the folds formed by said diaphragm, thereby achieving greater sound pressure with a lower distortion level.

The AMT-type acoustic transducer is formed basically of a magnetic circuit consisting of at least one magnet and two pole parts, wherebetween a diaphragm is disposed, composed in turn of a flexible printed circuit board manufactured from a polymer lamina whereto an electric circuit with straight tracks is adhered and positioned in such a manner that, on applying tension at the inlet, the direction of the current circulating through said circuit is conveniently oriented to exert certain forces.

The flexible printed circuit is folded in such a manner that the tracks are aligned in the accordion-like grooves. When an alternating current flows through said tracks, the forces arising from the interaction between the static magnetic field (produced by the magnet) and the alternating and variable field (produced by the current circulating along the tracks) causes the folds to close or open, whereupon the air trapped inside said folds is “clamped”, generating an acoustic signal the intensity of which will depend on the force applied to the folds and, therefore, on the intensity of said current.

On flowing through the tracks of the circuit or coil, heat is generated by the so-called Joule effect, which is simply the product of the electrical resistance of the tracks, which are made of copper or aluminium, multiplied by the square of the current intensity.

As there is very little movement in the folds, this heat is dissipated passively, by natural convection, due to which the tracks are heated to a high degree and, consequently, expand considerably.

However, as the diaphragm is fixed to a rigid frame, said expansion will not be possible, at least longitudinally. Consequently, the folds are laterally deformed until the required function is lost and these even come into contact with each other, which would destroy the tracks due to electrical short circuit.

Even if no damage is caused, a permanent dysfunction would be produced due to the fact that, on being formed by a polymer, the diaphragm would be deformed to such an extent that, on cooling, the track would not recover its original shape and, consequently, there is fast and irreversible degeneration.

Therefore, the loudspeaker advocated herein aims to avoid or lessen the adverse effects of the heat by implementing three complementary solutions, the first of which is a system that tenses the folds permanently, in such a manner that, when the folds expand on applying an electric current, they can effectively elongate freely without causing lateral deformation.

This has been possible due to the fixation of one of the longitudinal ends of the circuits to a steel strip which has been previously deformed towards the interior of the frame in the manner of a bow. The strip is constantly pulling the circuit in the direction of the folds. In the presence of an electric current, the expansion of the fold is no longer hampered by rigid ends, but rather each is free to elongate and, in turn, exert additional force to maintain said folds straight. When the current ceases and the circuit is cooled, the diaphragm can return to its original position and shape.

Additionally, as a result of the geometry of the diaphragm and fixation thereof (strip), the folds disposed on the sides are immobilised to a greater extent and therefore suffer more than the more internal folds, which are freer and subject to greater tension.

In these more external folds, the possibility of suffering damage due to high temperatures is greater than in the case of the internal folds, due to which a variable track width design is preferred, in such a manner that the external tracks have a greater width than the internal tracks. Therefore, electrical resistance will vary from one area to another, being smaller in external areas and greater in internal areas.

The reason for applying this solution is that the power dissipated in the circuit is proportional to the value of the square of the intensity of the electric current that flows through it multiplied by the electrical resistance. Therefore, the smaller the electrical resistance, the less heat will be generated, which is the desired objective.

As the force exerted to open or close the folds only depends on the circulating current and the intensity of the static magnetic field, no change will be observed on varying the track geometry and, consequently, in the acoustic result.

Lastly, for the purpose of supplementing these enhancements, a forced cooling system is applied by means of an air flow produced by a fan attached to the rear part of the loudspeaker. Taking advantage of the shape of the magnetic parts, with transverse grooves to allow the passage of sound from the diaphragm and longitudinal conduits created by the folds thereof, the air flow easily penetrates the pole plates and circulates through the folds, pushing the heat generated in the tracks towards the exterior and cooling the tracks, thereby avoiding or at least reducing expansion thereof. The fan is self-powered by the signal fed to the loudspeaker, once rectified and conditioned. The volume of air supplied will therefore be variable and proportional to the power applied. The greater the volume, the greater the heat that will be generated in the circuit and the greater the air flow that will be supplied by the fan.

Throughout the description and claims, the term “comprises” and its variants do not aim to exclude other technical characteristics, additions, components or steps. For persons skilled in the art, other objects, advantages and characteristics of the invention will depend partly on the description and partly on the practice of the invention. The following examples and drawings are provided by way of non-limiting example of the invention. In addition, the present invention envisages all the possible combinations of the particular and preferred embodiments indicated herein.

### BRIEF DESCRIPTION OF THE DRAWINGS

Following is a brief description of a series of drawings that help to better understand the invention and relate expressly to an embodiment of said invention that is provided as a non-limiting example thereof.

FIG. 1 shows a practical embodiment of the folded diaphragm loudspeaker object of the present utility model.

FIG. 2 shows a plan view of the loudspeaker, where FIG. 2A shows a detail of one of the ends of the tensioning system that forms part of the loudspeaker advocated herein.

FIG. 3 shows a view of the fan-forced ventilation system of the loudspeaker object of the present utility model.

FIG. 4 shows a schematic view of the circuit board printed on the diaphragm.

### PREFERRED EMBODIMENT OF THE INVENTION

The attached drawings show a preferred embodiment of the invention. More specifically, the folded diaphragm loudspeaker object of the present utility model is characterised in that it comprises a first magnetic circuit, consisting of at least one magnet and two pole parts (7) formed from a flexible printed circuit board, wherebetween a folded diaphragm (1) is housed.

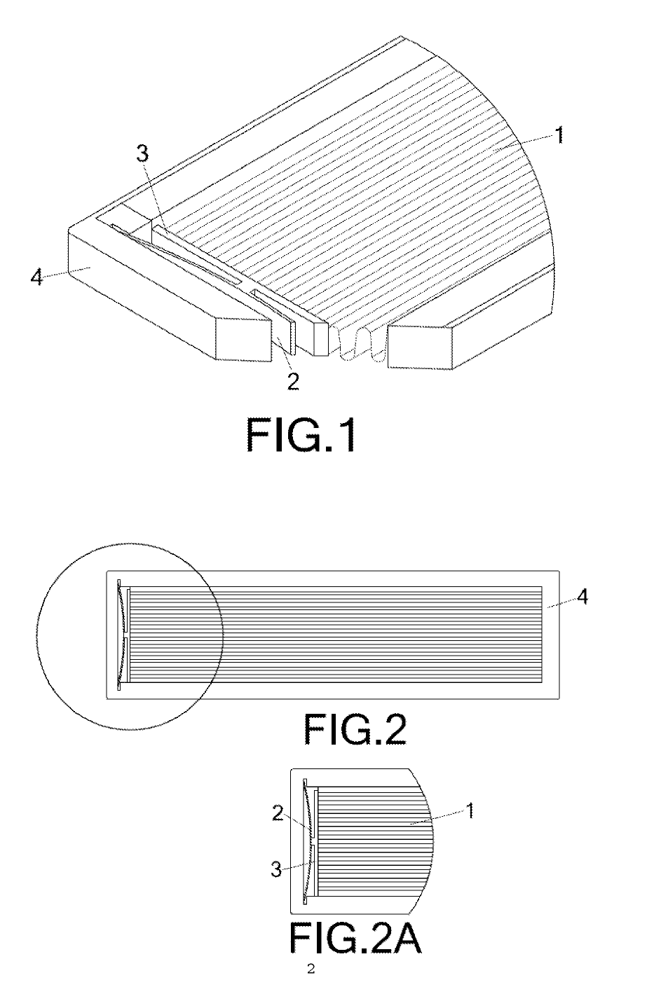

In order to dissipate the heat generated in said diaphragm (1), it is fixed in its entirety to a frame (4), while said folded diaphragm (1) is joined by one of its ends to a rigid support (3) associated with a bowed steel strip or band (2), the purpose of which is to continuously tense the folded diaphragm (1) in the direction of the folds thereof, as shown in FIGS. 1 and 2.

As a consequence of the shape of the diaphragm (1) and the strip (2), the folds disposed on the most external sides suffer more than the more internal folds. Therefore, said external folds have greater possibilities of suffering damages caused by the temperature. To mitigate this problem, said folds are designed with a greater width and cross-section (1a) with respect to the most internal folds (1b), in such a manner as to dissipate the heat in an optimised manner, as shown in FIG. 4.

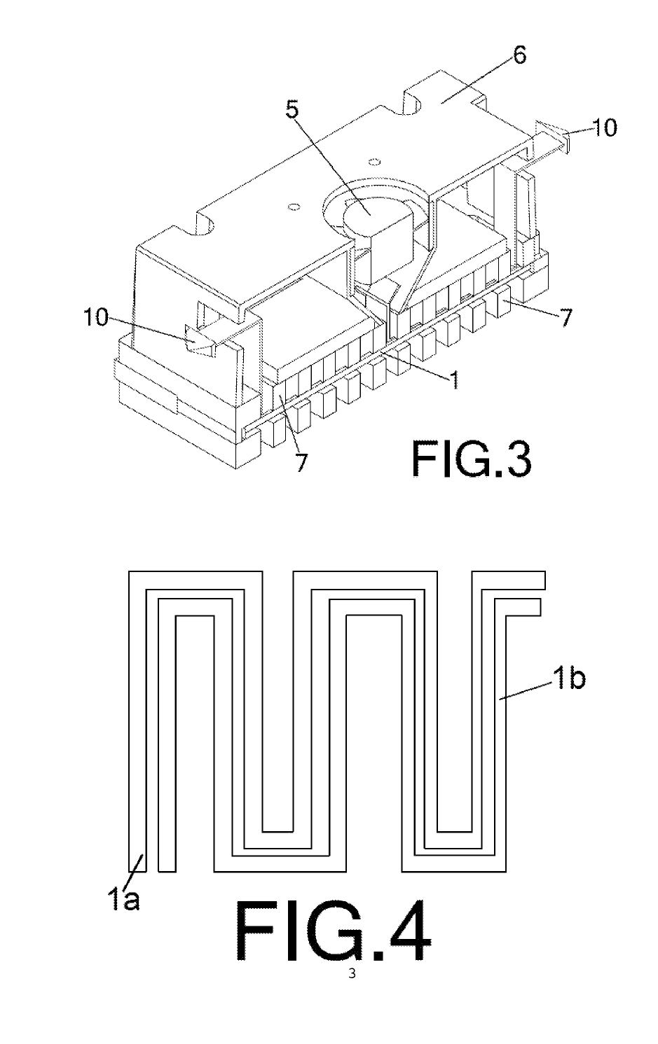

Lastly, the loudspeaker (6) can include a forced cooling system, as shown in FIG. 3, thanks to the use of a fan (5) embedded in the rear part of the loudspeaker (6).

Thanks to shape of the pole parts (7) and the transverse grooves which allow the passage of sound from the diaphragm (1) and its folds, the air flow (10) easily penetrates the pole parts (7) and circulates through the diaphragm (1), cooling and thus eliminating the heat generated in the circuit tracks.

The fan (5) will be powered by the signal fed to the loudspeaker, once rectified and conditioned.

1. Folded diaphragm loudspeaker of the type used in the manufacture of audio equipment, which comprises a first magnetic circuit board consisting of at least one magnet and two pole parts (7) formed from a flexible printed circuit board, where between a folded diaphragm (1) is housed, having folds with a greater cross-section in its most external part with respect to the internal folds, characterised in that the diaphragm (1) is fixed in its entirety to a frame (4), except in one of its ends, where the diaphragm (1) is joined to a rigid support (3) associated with a bowed steel strip or band (2) that tenses the folded diaphragm (1) in the direction of the folds thereof.

2. Loudspeaker, according to claim 1, wherein it includes a fan (5) embedded in the rear part of the loudspeaker (6).

3. Loudspeaker, according to claim 2, wherein the fan (5) is powered by the signal delivered by the loudspeaker, once rectified and conditioned.
